(19) United States
(12) Patent Application Publication
(10) Pub. No.: US 2022/0199291 A1
(43) Pub. Date: Jun. 23, 2022

(54) COMMUNICATION CABLE

(71) Applicant: Nissei Electric Co., Ltd., Shizuoka (JP)

(72) Inventors: Daisuke MOCHIZUKI, Shizuoka (JP); Masaumi AZUMA, Shizuoka (JP); Masahiro ISHIKAWA, Shizuoka (JP)

(21) Appl. No.: 17/599,814

(22) PCT Filed: Apr. 17, 2020
(86) PCT No.: PCT/JP2020/016907

§ 371 Date: Sep. 29, 2021

(30) Foreign Application Priority Data
Apr. 26, 2019 (JP) 2019-085722

(51) Int. Cl. H01B 11/04; H01B 7/18; H01B 7/04

(52) U.S. Cl. CPC H01B 11/04; H01B 7/04; H01B 7/18

(57) ABSTRACT

A communication cable (1) including a twisted wire pair (5) formed by twisting signal wires (2) each including an insulating layer (4) that covers a conductor (3), and an outer sheath (7) that accommodates the twisted wire pair (5). The communication cable is characterized in that the twisted wire pair (5) includes a pair of signal wires (2) and a pair of filler cords (6), and the signal wires (2) and the filler cords (6) are twisted together such that the signal wires (2) and the filler cords (6) are alternately arranged side by side.

### TECHNICAL FIELD

The present disclosure relates to a communication cable, and more particularly to a communication cable that is used for a signal transmission path for a LAN that satisfies standard values of Category 6 and Category 6A, and is preferably used for movable parts of robots including various service robots, such as an industrial robot and a humanoid, and various industrial apparatuses, such as a semiconductor manufacturing apparatus.

### BACKGROUND ART

A LAN cable having a structure in which an outer sheath is provided on an outer periphery of an assembly formed by collecting a plurality of twisted wire pairs is widely used as a typical communication cable. The communication cable is required to have a high-speed and large-volume data transmission function in accordance with the widespread use of communication devices and the resulting increased amount of communication data.

As a standard indicative of performance of the LAN cable, a standard called “Category” is used. Commonly used LAN cables are classified into Category 5, Category 5e, Category 6, Category 6A, and Category 7 in ascending order of performance, and it is recommended to use a LAN cable of Category not lower than Category 6 in the recent communication environment.

Further, in accordance with the widespread use of Internet of Things (IoT), there are an increasing number of examples in which a data communication function is installed in various industrial apparatuses and the like, represented by an industrial robot and a semiconductor device, and as a communication cable used for these apparatuses, the LAN cable is often used.

FIG. 8 shows a structure of a general LAN cable (communication cable) of Category 6. Usually, the communication cable, denoted by reference numeral 50, has a structure in which an outer sheath 57 is provided on an outer periphery of an assembly formed by collecting four twisted wire pairs 55 each formed by twisting two signal wires 52 together, and many of the communication cables 50 of Category 6 have a structure in which the four twisted wire pairs 55 are collected via a filler (cross-shaped filler 58) having a cross-shaped cross section. Distances between the twisted wire pairs 55 are maintained at a constant value or more by the cross-shaped filler 58 to thereby suppress crosstalk attenuation caused when the twisted wire pairs 55 are brought close to each other, and therefore the provision of the filler 58 contributes to improvement of communication characteristics.

However, when the general communication cable 50 using the cross-shaped filler 58 is used for an industrial robot or a semiconductor device, there is the following problem:

The industrial robot and the semiconductor device generally have movable parts, such as a rotating part, a bending part, and a U-shaped bending part, and in a communication cable used for these devices, load, such as bending load, is generated in accordance with movement of each device.

The cross-shaped filler 58 is low in flexibility because of its shape, and therefore it is difficult for the cross-shaped filler 58 to follow bending, so that the cross-shaped filler 58 is often limited in the amount of bending and is liable to be broken due to load generated by bending. In a case where the cross-shaped filler 58 is broken, there arises a situation in which the twisted wire pairs 55 in the communication cable 50 are brought close to each other to increase crosstalk attenuation, so that communication characteristics associated with the category cannot be obtained any longer.

As the LAN cable conforming to Category 6 using a method other than the cross-shaped filler, there are LAN cables described in Patent Literature 1 and 2. The LAN cable described in Patent Literature 1 satisfies standard values defined by Category 6 without using a filler by changing a twisting pitch of twisted wire pairs as components of the LAN cable on a twisted wire pair-by-twisted wire pair basis. The LAN cable described in Patent Literature 2 satisfies the standard values defined by Category 6 without using a filler by setting a twist angle of the twisted wire pairs as components of the LAN cable to a predetermined value.

However, the LAN cables described in Patent Literature 1 and 2 do not refer to preservation of communication characteristics in a situation where bending occurs. Particularly, in the LAN cable that does not use a filler, the twisted wire pairs as components of the LAN cable are always close to each other, and there is a fear that the communication characteristics are degraded when the twisted wire pairs are made abnormally close to each other by bending.

Further, focusing on a behavior of the twisted wire pairs as components of the LAN cable, there is a case where the cover of each of signal wires forming a twisted wire pair is compressed by load generated by bending, and a distance between the signal wires, particularly, a distance between conductors as components of the signal wires is sometimes changed in a bent portion. This change in the distance sometimes changes the effect of suppressing radiation of electromagnetic induction noise generated in the twisted wire pairs and the effect of shielding external electromagnetic induction noise, and this phenomenon is also a cause of degradation of the communication characteristics.

### CITATION LIST

### Patent Literature

Patent Literature 1: Unexamined Japanese Patent Application Publication No. 2014-2837

Patent Literature 2: Unexamined Japanese Patent Application Publication No. 2001-155559

### SUMMARY OF INVENTION

### Technical Problem

As described above, the conventional communication cable is inferior in bending durability, and when the communication cable is repeatedly bent, it becomes difficult to preserve the communication characteristics.

The present disclosure has been made under such circumstances, and an objective thereof is to provide a communication cable that is excellent in bending durability and preserves the communication characteristics even when the communication cable is repeatedly bent.

### Solution to Problem

A communication cable according to claim 1 is a communication cable including a twisted wire pair formed by twisting together signal wires each provided with an insulating layer for covering a conductor, and an outer sheath that accommodates the twisted wire pair, characterized in that the twisted wire pair includes a pair of signal wires and a pair of filler cords, and the signal wires and the filler cords are twisted together such that the signal wires and the filler cords are alternately arranged side by side.

The communication cable according to claim 2 is characterized in that a shield layer is provided between the twisted wire pair and the outer sheath.

The communication cable according to claim 3 is characterized in that an assembled wire formed by twisting a plurality of twisted wire pairs together is covered with the outer sheath.

The communication cable according to claim 4 is characterized in that a shield layer is provided between the assembled wire and the outer sheath.

The communication cable according to claim 5 is characterized in that in a cross-sectional view of the twisted wire pair on a plane orthogonal to a longitudinal direction, a pair of signal wires as components of the twisted wire pair are in contact with each other.

The communication cable according to claim 6 is characterized in that an outer diameter of the filler cord is smaller than an outer diameter of the signal wire.

The communication cable according to claim 7 is characterized in that when an outer diameter of the filler cord is defined as R₁ and an outer diameter of the signal wire is defined as R₂, a relationship expressed by an expression (1) is satisfied.

$$( \frac{2 \cdot \sqrt{3}}{3} - 1 ) {R}_{2} \leq {R}_{1} \qquad ( 1 )$$

The communication cable according to claim 8 is characterized in that when an outer diameter of the filler cord is defined as R₁ and an outer diameter of the signal wire is defined as R₂, a relationship expressed by an expression (2) is satisfied.

R₁≤⅔R₂ (2)

The communication cable according to claim 9 is characterized in that when an outer diameter of the filler cord is defined as R₁ and an outer diameter of the signal wire is defined as R₂, a relationship expressed by an expression (3) is satisfied.

$$( \frac{2 \cdot \sqrt{3}}{3} - 1 ) {R}_{2} \leq {R}_{1} \leq \frac{2}{3} {R}_{2} \qquad ( 3 )$$

The communication cable according to claim 10 is characterized in that elongation of the filler cord is greater than or equal to elongation of the signal wire.

The communication cable according to claim 11 is characterized in that elongation of the filler cord is greater than or equal to 10 times of elongation of the signal wire.

The communication cable according to claim 12 is characterized in that the filler cord is formed of a material having a kinetic coefficient of friction that is less than or equal to 0.3.

The communication cable according to claim 13 is characterized in that the filler cord is formed of a material having a static coefficient of friction that is less than or equal to a kinetic coefficient of friction.

### Advantageous Effects of Invention

According to the present disclosure, compression of the covers of signal wires as components of the twisted wire pair is suppressed, whereby a predetermined distance between the conductors is maintained even when the communication cable is bent, and therefore the predetermined communication characteristics are preserved.

### BRIEF DESCRIPTION OF DRAWINGS

FIG. 1 is an illustrative diagram of an example of the configuration of a communication cable according to the present disclosure;

FIG. 2 is an illustrative diagram of another example of the configuration of the communication cable according to the present disclosure;

FIG. 3 is an illustrative diagram useful in explaining twisted wire pairs of communication cables shown in FIGS. 1 and 2;

FIG. 4 is an illustrative diagram showing a state in which the twisted wire pairs of a communication cable shown in FIG. 2 are close to each other;

FIG. 5 is an illustrative diagram showing a testing method of a bending durability test;

FIG. 6A is an explanatory diagram showing communication cable transmission characteristics of Example 1;

FIG. 6B is an explanatory diagram showing communication cable transmission characteristics of Example 1;

FIG. 7A is an explanatory diagram showing communication cable transmission characteristics of Example 2;

FIG. 7B is an explanatory diagram showing communication cable transmission characteristics of Example 2;

FIG. 8 is an illustrative diagram showing a basic structure of a conventional communication cable having a cross-shaped filler;

FIG. 9 is an illustrative diagram of a case where a shield layer is provided on a conventional twisted wire pair having a structure in which only two signal wires are twisted together; and

FIG. 10 is an illustrative diagram showing a basic structure of a conventional communication cable that does not have a filler.

### DESCRIPTION OF EMBODIMENTS

Hereafter, the basic configuration of a communication cable of the present disclosure will be described with reference to accompanying drawings.

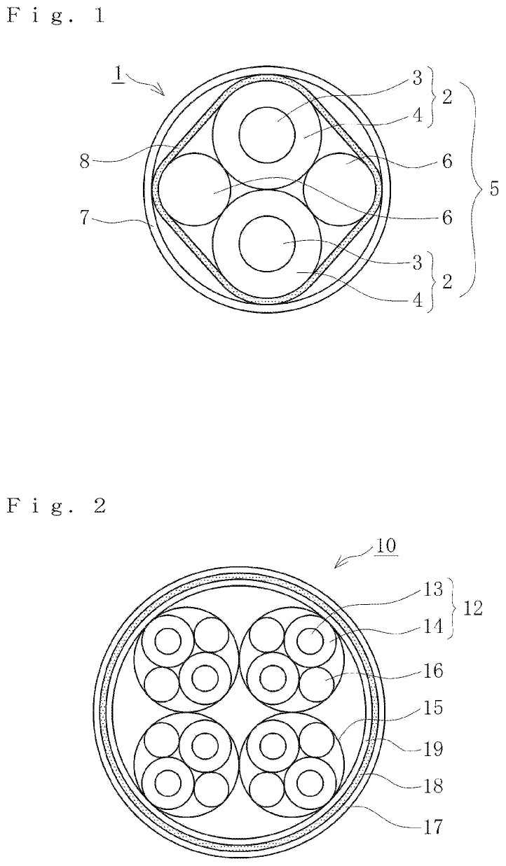

A communication cable 1 shown in FIG. 1 is comprised of a twisted wire pair 5 formed by twisting together a pair of signal wires 2 each having a structure in which a conductor 3 is covered with an insulating layer 4 and a pair of filler cords 6, and the twisted wire pair 5 is accommodated in an outer sheath 7. The communication cable 1 is, particularly, an example in which a shield layer 8 is provided that collectively covers the signal wires 2 and the filler cords 6, which are accommodated in the outer sheath 7 (however, the shield layer is not necessarily required for the communication cable).

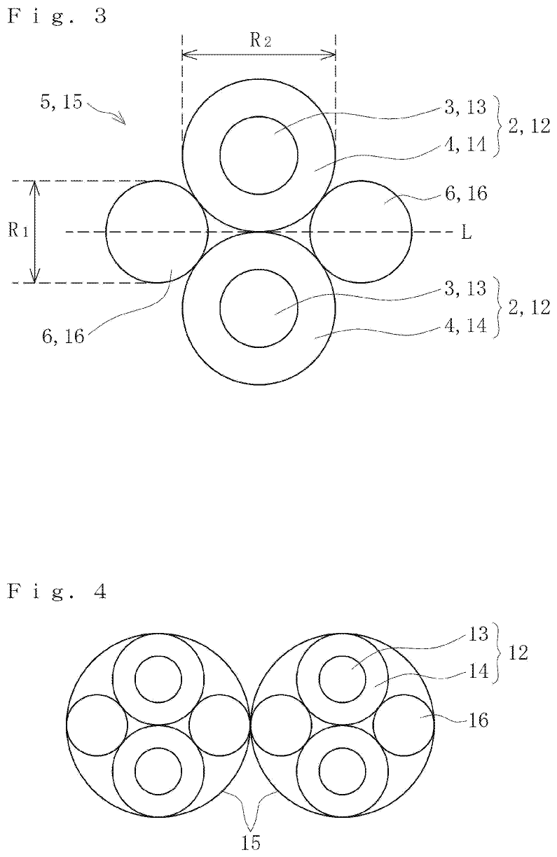

Further, a communication cable 10 shown in FIG. 2 is comprised of a twisted wire pair 15 formed by twisting together a pair of signal wires 12 each having a structure in which a conductor 13 is covered with an insulating layer 14 and a pair of filler cords 16, and an assembled wire formed by twisting a plurality of the twisted wire pairs 15 together is accommodated in an outer sheath 17. The communication cable 10 is, particularly, an example in which a shield layer 18 is provided that covers the communication wire accommodated in the outer sheath 17 (however, the shield layer is not necessarily required for the communication cable). Further, the communication cable 10 is, particularly, an example in which a tape layer 19 is provided between the shield layer 18 and the assembled wire (however, the tape layer is not necessarily required for the communication cable).

The present disclosure is characterized in that as shown in FIG. 3, the twisted wire pair 5, 15 as a component of the communication cable 1, 10 includes the pair of signal wires 2, 12 and the pair of filler cords 6, 16, and by a structure in which the signal wires 2, 12 and the filler cords 6, 16 are twisted together such that the signal wires 2, 12 and the filler cords 6, 16 are alternately arranged side by side.

Since the signal wires 2, 12 and the filler cords 6, 16 are twisted together such that the signal wires 2, 12 and the filler cords 6, 16 are alternately arranged side by side, when the twisted wire pair 5, 15 is bent in accordance with bending of the communication cable 1, 10, particularly, when bent along a line L indicated in FIG. 3, part of load that acts to compress the insulating layers 4, 14 is absorbed by the filler cords 6, 16. As a result, the load applied to the insulating layers 4, 14 when the twisted wire pair 5, 15 is bent is reduced, whereby compression of the insulating layers 4, 14 is suppressed.

Since compression of the insulating layers 4, 14 is suppressed, a change in distance between the conductors 3, 13 of the signal wires 2, 12 as components of the twisted wire pair 5, 15 is reduced, whereby changes in the effect of suppressing radiation of electromagnetic induction noise and the effect of shielding external electromagnetic induction noise, which are to be provided by the twisted wire pair 5, 15, are reduced. As a result, a change in communication characteristics, caused by bending of the communication cable 1, 10 using the twisted wire pair 5, 15, is suppressed, which contributes to the preservation of the predetermined communication characteristics.

Further, since the load generated when the communication cable 1, 10 is bent is absorbed by the filler cords 6, 16, the load applied to the signal wires 2, 12 is reduced, which also makes it possible to suppress disconnection of the conductors 3, 13, caused by bending of the communication cable 1, 10.

Furthermore, since the filler cords 6, 16 are twisted together, the effect of improving the bending durability of the shield layer 8, 18 can also be obtained as described hereinafter.

In most instances, the communication cable 1, 10 is formed, as shown in FIGS. 1 and 2, by providing the shield layer 8, 18 that collectively covers the signal wires accommodated in the outer sheath 7, 17.

As shown in FIG. 9, in general, in a case where a shield layer 68 is provided on a twisted wire pair 65 having a structure in which only two signal wires 62 are twisted together, a portion exists where the shield layer 68 has a substantially elliptic shape, and this portion has a cross-sectional shape with a major axis and a minor axis.

In a case where the communication cable including this shield layer 68 having the cross-sectional shape with the major axis and the minor axis is bent, since there is a dimensional difference between the major axis and the minor axis, load generated in the shield layer 68 tends to have unevenness and concentrate at a specific location. For this reason, the shield layer 68 is liable to be broken from where the load concentrates.

On the other hand, when the shield layer 8 is provided, the shape of the twisted wire pair 5 used for the present disclosure becomes a substantially square shape as shown in FIG. 1, which substantially eliminates the dimensional difference between the major axis and the minor axis. Therefore, the load generated in the shield layer 8 when the communication cable 1 is bent is uniformly dispersed, so that the shield layer 8 is suppressed from being broken. As a result, this contributes to improvement of the bending durability of the communication cable 1.

Further, existence of the filler cords 6 also contributes to reduction of a diameter of the communication cable 1 as described hereafter.

In a case where the shield layer 68 is provided on the twisted wire pair 65 formed by twisting only the signal wires 62 together, the shield layer 68 is close to the signal wires 62 as shown in FIG. 9, and two spaces surrounded by the two signal wires 62 and the shield layer 68 are formed. On the other hand, in a case where the shield layer 8 is provided on the twisted wire pair 5 in which the filler cords 6 are also twisted together, not only two spaces surrounded by the two signal wires 2 and the filler cords 6, but also four spaces surrounded by the signal wires 2, the filler cords 6, and the shield layer 8 are formed, due to existence of the filler cords 6.

The formed spaces provide the effect of reducing an effective dielectric constant of the twisted wire pair 5 surrounded by the shield layer 8, and as the number of the formed spaces is larger, the effective relative dielectric constant is more reduced.

When setting a characteristic impedance of the twisted wire pair 5, although it is necessary to adjust a distance between the conductors according to the effective dielectric constant of the twisted wire pair 5, when the effective dielectric constant is reduced, the distance between the conductors required to be provided for setting the characteristic impedance to a predetermined characteristic impedance is reduced, and therefore it is possible to thin the outer diameter of each signal wire 2, and as a result, it is possible to thin the outer diameter of the twisted wire pair 5.

That is, the twisted wire pair 5 in which the filler cords 6 are twisted has a lot of spaces formed therein due to existence of the filler cords 6, and therefore, the effective relative dielectric constant is largely reduced. The outer diameter of the twisted wire pair 5 can be set to be thinner compared with a case where the filler cords 6 are not twisted together, and therefore, existence of the filler cords 6 contributes to reduction of the diameter of the communication cable 1 using the twisted wire pair 5.

In addition to the above, signal attenuation caused by dielectric loss is also suppressed in accordance with reduction of the effective relative dielectric constant, and therefore, existence of the filler cords 6 contributes to improvement of the communication characteristics as well.

As described above, the twisted wire pair 15 formed by alternately twisting the signal wires 12 and the filler cords 16 together contributes to the preservation of the communication characteristics even in a case where the communication cable 10 is formed by using the assembled wire in which the plurality of twisted wire pairs 15 are twisted together as shown in FIG. 2.

In the communication cable 10 having the plurality of twisted wire pairs 15, shown in FIG. 2, if the twisted wire pairs 15 are brought close to each other, crosstalk attenuation in which a signal transmitted through the signal wires 12 as components of one of the twisted wire pairs 15 is transmitted to the signal wires 12 as components of the other of the twisted wire pairs 15 is liable to occur, so that the communication characteristics of the communication cable 10 are lowered by the crosstalk attenuation.

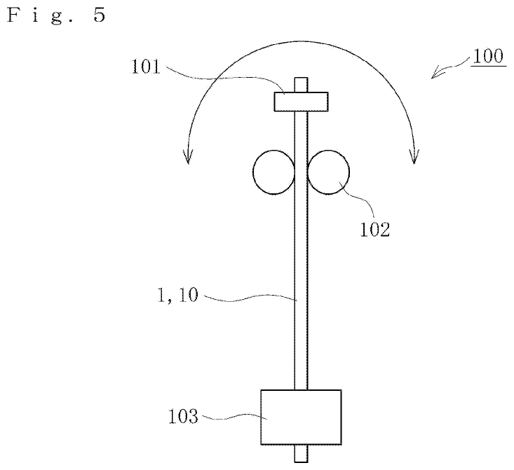

When the twisting pitch of each twisted wire pair 15 as a component of the communication cable 10 is set to a different value for each twisted wire pair 15, crosstalk attenuation which markedly lowers the communication characteristics is not confirmed insofar as the twisted wire pairs 15 are close to each other to such a degree that the outer diameter circles of the twisted wire pairs 15 are in contact with each other as shown in FIG. 4, and the communication characteristics of the communication cable 10 are preserved.

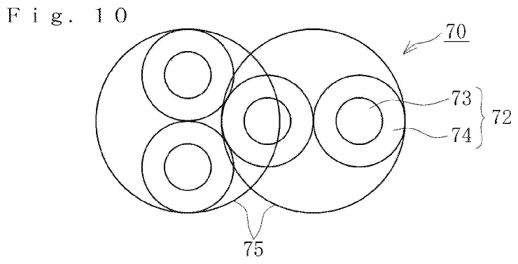

However, as shown in FIG. 10, in a communication cable 70 that has no filler cords, if twisted wire pairs 75 are close to each other to such a degree that the outer diameter circles of the twisted wire pairs 75 overlap each other, crosstalk attenuation is increased, particularly, if one of signal wires 72 as components of one of the twisted wire pairs 75 enters a space between the two signal wires 72 as components of the other twisted wire pair 75 and is brought into contact with the two signal wires 72 as components of the other twisted wire pair 75, it can be confirmed that the communication characteristics are lowered.

In the present disclosure, by twisting the filler cords 16 together in the twisted wire pair 15, the signal wires 12 as components of the twisted wire pairs 15 are restricted from becoming abnormally close to each other to suppress crosstalk attenuation, whereby the communication characteristics of the communication cable 10 are preserved.

The twisted wire pair 15 of the communication cable 10 used for the present disclosure has the pair of signal wires 12 and the pair of filler cords 16, and has a structure in which the signal wires 12 and the filler cords 16 are twisted together such that the signal wires 12 and the filler cords 16 are alternately arranged side by side. Therefore, occurrence of such a case, as shown in FIG. 10, is prevented where one of the signal wires 72 as components of the twisted wire pairs 15 enters a space between the two signal wires 72 as components of the other twisted wire pair 75 and is brought into contact with the two signal wires 72 as components o the other twisted wire pair 75, and it is possible to preserve the predetermined communication characteristics.

The abnormal proximity of the twisted wire pairs 75 shown in FIG. 10 is liable to occur when the communication cable 70 is bent, and therefore, by twisting the filler cords 16 together in the twisted wire pair 15, degradation of the communication characteristics, caused by bending, is suppressed.

In addition, since the filler cords 16 exist within the outer sheath 17 in a state twisted together with the signal wires 12, the communication cable 10 of the present disclosure is excellent in bending durability, compared with the communication cable 50 using the cross-shaped filler.

Further, in the present disclosure, as shown in FIG. 3, in a cross-sectional view of the pair of signal wires 2, 12 as components of the twisted wire pair 5, 15, it is preferable that the pair of signal wires 2, 12 are twisted together such that the signal wires 2, 12 are brought into contact with each other.

Since the signal wires 2, 12 as components of the twisted wire pair 5, 15 are in contact with each other, the effect of suppressing radiation of electromagnetic induction noise and the effect of shielding external electromagnetic induction noise, which are to be provided by the twisted wire pair 5, 15 due to the structure of the twisted wire pair 5, 15 are stabilized, which contributes to the preservation of the communication characteristics.

In addition, in the present disclosure, it is preferable that the outer diameter of the filler cord 6, 16 is smaller than the outer diameter of the signal wire 2, 12. By making the outer diameter of the filler cord 6, 16 smaller than the outer diameter of the signal wire 2, 12, the filler cord 6, 16 is suppressed from preventing contact between the signal wires 2, 12 as components of the twisted wire pair 5, 15, and the outer diameter of the twisted wire pair 5, 15 is reduced, which contributes to reduction of the diameter of the communication cable 1, 10.

When the outer diameter of the filler cord 6, 16 is defined as R₁, and the outer diameter of the signal wire 2, 12 is defined as R₂, it is preferable that the outer diameter R₁ of the filler cord 6, 16 is within a range expressed by the following expression (1):

$$( \frac{2 \cdot \sqrt{3}}{3} - 1 ) {R}_{2} \leq {R}_{1} \qquad ( 1 )$$

Since the outer diameter R₁ of the filler cord 16 is set within the range expressed by the expression (1), even in a case where the twisted wire pairs 15 become close to each other in the communication cable 10 formed by twisting the plurality of twisted wire pairs 15 together, it is possible to suppress the signal wires 12 as components of the twisted wire pair 15 from becoming close to the signal wires 12 as components of the other twisted wire pair 15 to such a level degree that the communication characteristics are affected, which contributes to the preservation of the communication characteristics.

Further, it is preferable that R₁ is within a range expressed by the following expression (2):

R₁≤⅔R₂ (2)

Since the outer diameter R₁ of the filler cord 6, 16 is set within the range expressed by the expression (2), the outer diameter of the twisted wire pair 5, 15 is suppressed from being increased by existence of the filler cords 6, 16, which contributes to thinning of the diameter of the communication cable 1, 10. Further, in a case where the outer diameter R₁ of the filler cord 16 is close to an upper limit value of the range expressed by the expression (2), the twisted wire pair 15 has a circular shape as a whole, and the spaces between the twisted wire pairs 15, formed when the outer sheath 17 is provided, are reduced in the communication cable 10 formed by twisting the plurality of twisted wire pairs 15 together, and therefore the positional relationship between the twisted wire pairs 15 is difficult to be broken when the communication cable 10 is bent, which contributes to the preservation of the communication characteristics.

To summarize the above, a particularly preferable range of R₁ in the present disclosure is a range expressed by the following expression (3):

$$( \frac{2 \cdot \sqrt{3}}{3} - 1 ) {R}_{2} \leq {R}_{1} \leq \frac{2}{3} {R}_{2} \qquad ( 3 )$$

Since the outer diameter R₁ of the filler cord 6, 16 is within the range expressed by the expression (3), it is possible to suppress the signal wires 2, 12 from becoming close to each other to such a degree that the communication characteristics are affected, and suppress an increase in the outer diameter of the twisted wire pair 5, 15, which contributes to both of the preservation of the communication characteristics and the reduction of the diameter.

It is preferable that the filler cord 6, 16 used for the present disclosure uses a material having high slidability. By using the filler cord 6, 16 excellent in slidability, frictional resistance is reduced between the twisted wire pair 5 and an inner peripheral surface of the outer sheath 7, and also between the twisted wire pairs 15 in a case where the plurality of twisted wire pairs 15 are used, whereby the sliding of the twisted wire pair 5, 15, which occurs when the communication cable 1, 10 is bent, becomes smooth. As a result, load generated in the twisted wire pair 5, 15 is reduced, and it is possible to suppress disconnection of the signal wires 2, 12, caused by bending, which contributes to improvement of the bending durability of the communication cable 1, 10.

In addition, in a case where the tape layer 19 and/or the shield layer 8, 18 for noise suppression, described hereinafter, are provided between the twisted wire pair 5, 15 and the outer sheath 7, 17, the tape layer 19 and the shield layer 8, 18 are suppressed from being damaged due to wear, by using the material having high slidability for the filler cords 6, 16, which also contributes to the preservation of the communication characteristics.

More specifically, it is preferable to use a material having a kinetic coefficient of friction that is less than or equal to 0.3 for the filler cord 6, 16. Examples of the material having a kinetic coefficient of friction that is less than or equal to 0.3 include fluororesin, polyethylene, and nylon 66.

More preferably, a material having a static coefficient of friction that is less than or equal to a kinetic coefficient of friction is used for the filler cord 6, 16. Common materials have a static coefficient of friction larger than a kinetic coefficient of friction, but some of slidable materials include ones having a static coefficient of friction that is less than or equal to a kinetic coefficient of friction. By using such a material for the filler cord 6, 16, sliding of the twisted wire pair 5, 15, which occurs when the communication cable 1, 10 is bent, becomes more smooth, which contributes to improvement of the bending durability of the communication cable 1, 10.

Note that “the material having a static coefficient of friction that is less than or equal to a kinetic coefficient of friction” in the present disclosure refers to a material exhibiting a property that the static coefficient of friction is that is less than or equal to the kinetic coefficient of friction when the same materials are brought into contact and slide with each other. Further, the kinetic coefficient of friction and the static coefficient of friction in the present disclosure are values measured according to JIS K 7125.

Further, it is preferable that elongation of the filler cord 6, 16 is greater than or equal to elongation of the signal wire 2, 12. Since elongation of the filler cord 6, 16 is greater than or equal to elongation of the signal wire 2, 12, disconnection of the filler cord 6, 16 when bent is suppressed, which contributes to the preservation of the communication characteristics when the communication cable 1, 10 is bent.

More preferably, elongation of the filler cord 6, 16 is greater than or equal to 10 times of elongation of the signal wire 2, 12. Since elongation of the filler cord 6, 16 is sufficiently large compared with elongation of the signal wire 2, 12, the effect of suppressing disconnection of the filler cord 6, 16 when bent and the effect of preserving the communication characteristics are improved.

The filler cord 6, 16 used for the present disclosure can be selected from a monofilament type or a multi-filament type as appropriate.

From a viewpoint of the preservation of the communication characteristics, it is preferable that the filler cord 6, 16 is of the monofilament type which is difficult to be deformed when bent. By using the filler cord 6, 16 of the monofilament type which is difficult to be deformed, compression of the insulating layer 4, 14 in the twisted wire pair 5, 15 is suppressed, and in a case where the plurality of twisted wire pairs 15 are used, the twisted wire pairs 15 are suppressed from becoming close to each other, which contributes to the preservation of the communication characteristics, and the filler cord 6, 16 of the monofilament type is preferable in that the filler cord 6, 16 of the monofilament type has less unevenness on its surface and is also excellent in slidability.

A specific material of the filler cord 6, 16, particularly preferably used in the present disclosure, is PTFE which is a kind of fluororesin. The PTFE has a static coefficient of friction that is less than or equal to a kinetic coefficient of friction, and has excellent mechanical strength, such as high elongation. In addition, the PTFE has a low dielectric constant, and therefore transmission loss occurring when the filler cords 6, 16 are twisted together with the signal wires 2, 12 is suppressed, which also contributes to the preservation of the communication characteristics.

PFA, FEP, and ETFE as other fluororesin materials also have a static coefficient of friction that is less than or equal to a kinetic coefficient of friction, and has high elongation and a low dielectric constant, and therefore these fluororesin materials can be preferably used for the present disclosure.

Further, from the viewpoint of the preservation of the communication characteristics, the filler cord 6, 16 may have a porous structure or hollow structure. The porous structure and the hollow structure contain air and therefore exhibit a lower dielectric constant compared with a solid structure, thereby contributing to the preservation of the communication characteristics, and further are excellent in flexibility, and therefore also contribute to improvement of bending durability.

As the filler cord 6, 16 having the porous structure, expanded PTFE having a porous structure of nodes and fibrils, which is formed by stretching performed in the manufacturing process thereof, can be preferably used. The expanded PTFE is excellent in mechanical strength with respect to elongation, and therefore the expanded PTFE can be preferably used also from a viewpoint of improvement of bending durability.

As the filler cord 6, 16 having the hollow structure, one generated by extruding fluororesin into a tube shape can be used.

In addition, the filler cord 6, 16 having a low dielectric constant can be preferably used also from a viewpoint of thinning of the diameter of the communication cable 1, 10.

Although a LAN cable (communication cable 10) using four twisted wire pairs exists as an example of the communication cable, the conventional LAN cable has an outer diameter of approximately 5 to 7 mm, and a LAN cable having an outer diameter that is less than or equal to 5 mm tends to be treated as a thin-diameter cable.

In a case where the outer diameter of the LAN cable is made that is less than or equal to 5 mm, it is preferable to make the outer diameter of the twisted wire pair 15 that is less than or equal to 1 mm, and to reduce the outer diameter of the twisted wire pair 15, it is required to make the effective relative dielectric constant sufficiently small. By using the filler cord 16 having a low dielectric constant and by utilizing the action of lowering the effective relative dielectric constant due to existence of the spaces formed by the filler cords 16, it is possible to sufficiently reduce the effective relative dielectric constant of the twisted wire pair 15.

To make the outer diameter of the twisted wire pair 15 that is less than or equal to 1 mm, it is preferable to use the filler cord 16 formed of a material having a dielectric constant not higher than 2.4, and various fluororesin materials can be preferably used. From among the fluororesin materials, PTFE can be particularly preferably used.

In a case where the communication cable 10 is formed by using the plurality of twisted wire pairs 15, the twisted wire pairs 15 which are the same in twisting direction may be used, and the twisted wire pairs 15 which are different in twisting direction may be used in combination.

From the viewpoint of the preservation of the communication characteristics, it is preferable to combine the twisted wire pairs 15 which are different in twisting direction. By differentiating the twisting direction of the twisted wire pairs 15, the orientation of the unevenness existing on the surface of each twisted wire pair 15 is made different, whereby it is possible to suppress the twisted wire pairs 15 from becoming close to each other to such a degree that the outer diameter circles overlap each other.

In the present disclosure, since existence of the filler cords 16 makes it possible to suppress the twisted wire pairs 15 from becoming close to each other to such a degree that the outer diameter circles overlap each other, the present disclosure can be particularly preferably used in a case where the twisted wire pairs 15 are twisted in the same twisting direction.

As the conductor 3, 13 for the present disclosure, a suitable one of known conductors for electric wires and cables can be selected and used. From a viewpoint of bending durability and twist resistance, it is preferable to select one having a configuration excellent in bending durability and twist resistance.

As the insulating layer 4, 14 for the present disclosure, a suitable one of known insulating materials for electric wires and cables can be selected and used. From the viewpoint of bending durability, similar to the filler cord 6, 16, fluororesin, such as PTFE, PFA, FEP, and ETFE can be preferably used.

Further, the communication cable 1, 10 of the present disclosure can further improve the bending durability by a combination of the material of the filler cord 6, 16 as a component of the twisted wire pair 5, 15 and the material of the insulating layer 4, 14 used for the signal wire 2, 12.

As an example, there may be mentioned a form in which a material having a flexural modulus larger than that of the filler cord 6, 16 is used for the insulating layer 4, 14. Since the flexural modulus of the insulating layer 4, 14 is larger than that of the filler cord 6, 16, when the communication cable 1, 10 is bent, the filler cords 6, 16 are largely deformed, compared with the insulating layers 4, 14. As a result, the bending load is mainly absorbed by the filler cords 6, 16, which contributes to the suppression of the insulating layers 4, 14 from being broken, and the conductors 3, 13 from being disconnected.

As another example, there may be mentioned a form in which a material having a tensile modulus smaller than that of the filler cord 6, 16 is used for the insulating layer 4, 14. When the communication cable 1, 10 is bent, a force for pulling the twisted wire pair 5, 15 toward the opposite sides of the bent portion is generated. At this time, since the tensile modulus of the insulating layer 4, 14 is smaller than that of the filler cord 6, 16, tensile deformation of the insulating layer 4, 14 as a component of the signal wire 2, 12 twisted together with the filler cord 6, 16 is not liable to be caused until tensile deformation of the filler cord 6, 16 is started. That is, the tensile load is mainly absorbed by the filler cords 6, 16, which contributes to the suppression of the insulating layer 4, 14 from being broken and the conductors 3, 13 from being disconnected.

In a case where the filler cord 6, 16 made of PTFE, which is particularly preferably used in the present disclosure, is used, a material that can be preferably used for the insulating layer 4, 14 is FEP which shows a tendency that the flexural modulus is larger than that of PTFE and the tensile modulus is small.

In addition, a form in which the insulating layer 4, 14 and the filler cord 6, 16 are formed of the same kind of material can also be preferably used. In a case where the insulating layer 4, 14 and the filler cord 6, 16 are formed of the same kind of material, when the communication cable 1, 10 is bent, load generated on the signal wires 2, 12 and the filler cords 6, 16 is almost uniformly dispersed to the signal wires 2, 12 and the filler cords 6, 16, and therefore concentration of the load on the signal wires 2, 12 is suppressed, which contributes to the suppression of the insulating layer 4, 14 from being broken and the conductors 3, 13 from being disconnected.

Examples of the form in which the insulating layer 4, 14 and the filler cord 6, 16 are formed of the same kind of material include a form in which PEP is used for the both and a form in which PFA is used for the both.

Although in the above description, the insulated electric wire formed by covering the conductor 3, 13 with the insulating layer 4, 14 is employed as the signal wire 2, 12, the structure of the signal wire 2, 12 is not limited to this, but a known coaxial cable can be used as the signal wire 2, 12.

As the outer sheath 7, 17, a suitable one of known materials for outer sheathes of cables, such as PVC and silicone rubber, can be selected and used, as appropriate.

The tape layer 19 for covering the twisted wire pairs 15 or the shield layer 18 for noise suppression may be provided between the twisted wire pairs 15 and the outer sheath 17 as shown in FIG. 2. Further, although the present disclosure focuses on acquisition of the communication cable having excellent communication characteristics without using a cross-shaped filler, a variation using a cross-shaped filler may be employed on an as needed basis.

Hereafter, as examples of the present disclosure, the communication cable 1, 10 formed by using one twisted wire pair 5 or four twisted wire pairs 15 will be described.

### Example 1

As shown in FIG. 2, the communication cable 10 of Example 1 used the four twisted wire pairs 15, and the signal wire 12 and the filler cord 16 used for the twisted wire pair 15 were commonly designed for each twisted wire pair 15.

As the signal wire 12, a signal wire formed by covering an outer periphery of the conductor 13 formed by a tin-plated soft copper wire having a diameter of 0.26 mm with FEP as the insulating layer 14, which was formed to have a thickness of 0.16 mm by using an extrusion molding machine, such that the signal wire had an outer diameter of 0.58 mm, was prepared. Elongation of the signal wire 12 was less than 10%.

As the filler cord 16, PTFE fiber having a diameter of 0.38 mm was prepared. The diameter of this filler cord 16 was approximately equal to an upper limit value of the range expressed by the above expression (2). Further, elongation of the filler cord 16 was not less than 200%.

The twisted wire pair 15 included the two signal wires 12 and the two filler cords 16, and was formed by twisting the signal wires 12 and the filler cords 16 together such that the signal wires 12 and the filler cords 16 were alternately arranged side by side. The twisting pitch was changed for each twisted wire pair 15, whereby four types of the twisted wire pairs 15 were prepared.

The twisting directions of the twisted wire pairs 15 were unified to the same direction. Further, each twisted wire pair 15 had the signal wires 12 brought into contact with each other in a cross-sectional view when twisting was completed, and the outer diameter was 1.2 mm.

The four prepared twisted wire pairs 15 were all twisted together to form an assembled wire. The twisting direction of the assembled wire was set to be opposite to the twisting direction of the twisted wire pairs 15. The diameter of the twisted wire pairs 15 which were all twisted together was 2.8 mm.

An aluminum laminated polyethylene terephthalate (PET) tape was laterally wound as the tape layer 19 on an outer periphery of the twisted wire pairs 15 which were all twisted together.

Then, the shield layer 18 was provided on an outer periphery of the tape layer 19. The shield layer 18 was a braided shield formed by 16 sets of strand bundles each of which was formed by arranging eight shield strands in parallel, and as the shield strand, a copper foil thread having an outer diameter of 0.08 mm was used.

Finally, an outer periphery of the shield layer 18 was covered with polyvinyl chloride (PVC) as the outer sheath 17 which was formed to have a thickness of 0.4 mm by using an extrusion molding machine, whereby the communication cable 10 of Example 1 was completed. The outer diameter of the communication cable 10 was finally 4 mm.

### Example 2

A communication cable of Example 2 had the same structure as that of Example 1, and therefore the description was given with reference to FIG. 2. The communication cable 10 of Example 2 used the four twisted wire pairs 15, and the signal wire 12 and the filler cord 16 used for the twisted wire pair 15 were commonly designed for each twisted wire pair 15.

As the signal wire 12, a signal wire formed by covering an outer periphery of the conductor 13 having an outer diameter of 0.24 mm and formed by coaxially twisting seven tin-plated soft copper wires each having a diameter of 0.08 mm, with PEP as the insulating layer 14, which was formed to have a thickness of 0.095 mm by using an extrusion molding machine, such that the signal wire had an outer diameter of 0.43 mm, was prepared. Elongation of the signal wire 12 was less than 10%.

As the filler cord 16, PTFE fiber having a diameter of 0.42 mm was prepared. The diameter of this filler cord 16 was approximately equal to the diameter of the signal wire 12 and was out of the range expressed by the above expression (2). Further, elongation of the filler cord 16 was not less than 200%.

The twisted wire pair 15 included the two signal wires 12 and the two filler cords 16, and was formed by twisting the signal wires 12 and the filler cords 16 together such that the signal wires 12 and the filler cords 16 were alternately arranged side by side. The twisting pitch was changed for each twisted wire pair 15, whereby four types of the twisted wire pairs 15 were prepared.

The twisting directions of the twisted wire pairs 15 were unified to the same direction. Further, each twisted wire pair 15 had the signal wires 12 brought into contact with each other in a cross-sectional view when twisting was completed, and the outer diameter was 0.9 mm.

The four prepared twisted wire pairs 15 were all twisted together to form an assembled wire. The twisting direction of the assembled wire was set to be opposite to the twisting direction of the twisted wire pairs 15. The diameter of the twisted wire pairs 15 which were all twisted together was 2.8 mm.

An aluminum laminated polyethylene terephthalate (PET) tape was laterally wound as the tape layer 19 on an outer periphery of the twisted wire pairs 15 which were all twisted together.

Then, the shield layer 18 was provided on an outer periphery of the tape layer 19. The shield layer 18 was a braided shield formed by 16 sets of strand bundles each of which was formed by arranging eight shield strands in parallel, and as the shield strand, a copper foil thread having an outer diameter of 0.08 mm was used.

Finally, an outer periphery of the shield layer 18 was covered with polyvinyl chloride (PVC) as the outer sheath 17 which was formed to have a thickness of 0.4 mm by using an extrusion molding machine, whereby the communication cable 10 of Example 2 was completed. The outer diameter of the communication cable 10 was finally 4 mm.

### Example 3

The communication cable 1 of Example 3 used only one twisted wire pair 5 as shown in FIG. 1.

As the signal wire 2, a signal wire formed by covering an outer periphery of the conductor 3 formed as an assembled twisted wire by twisting together three twisted wires each formed by twisting seven tin-plated copper alloy wires each having a diameter of 0.05 mm, with PEP as the insulating layer 4, which was formed to have a thickness of 0.15 mm by using an extrusion molding machine, such that the signal wire had an outer diameter of 0.58 mm, was prepared. Elongation of the signal wire 2 was less than 10%.

As the filler cord 6, PTFE fiber having a diameter of 0.38 mm was prepared. The diameter of this filler cord 6 was approximately equal to an upper limit value of the range expressed by the above expression (2). Further, elongation of the filler cord 6 was not less than 200%.

The twisted wire pair 5 was formed by twisting the two signal wires 2 and the two filler cords 6 together such that the signal wires 2 and the filler cords 6 were alternately arranged side by side. The completed twisted wire pair 5 had the signal wires 2 brought into contact with each other in a cross-sectional view when twisting was completed, and the diameter was 1.2 mm.

Then, the shield layer 8 was provided on an outer periphery of the signal wires 2 and the filler cords 6. The shield layer 8 was a braided shield formed by 24 sets of strand bundles, each set being formed by arranging seven shield strands in parallel, and as the shield strand, a copper foil thread having an outer diameter of 0.08 mm was used.

Finally, an outer periphery of the shield layer 8 was covered with polyvinyl chloride (PVC) as the outer sheath 7 which was formed to have a thickness of 0.4 mm by using an extrusion molding machine, whereby the communication cable 1 of Example 3 was completed. The outer diameter of the communication cable 1 was finally 2.3 mm.

### COMPARATIVE EXAMPLE

As a communication cable of Comparative Example with respect to Example 3, a communication cable made similar to the communication cable of Example 3 except that the filler cord 6 was omitted from the communication cable 1 of Example 3 was prepared.

The transmission characteristics of the communication cables of Examples and Comparative Example made as described above were compared before and after a bending durability test. Note that there were differences in durability and items which could be evaluated due to differences in dimension and structure between the communication cable 10 of Examples 1 and 2, which were formed by the plurality of twisted wire pairs 15, and the communication cables of Example 3 and Comparative Example, which were formed by one twisted wire pair 5, and therefore test conditions and evaluation items were partially changed, by considering these differences, as will be described in detail hereafter.

### Transmission Characteristics Evaluation Method with Respect to Examples 1 and 2

Near end cross talk (NEXT) of the communication cable 10 was evaluated by a method compliant with TIA/EIA-568-B.2-1, and the quality of the transmission characteristics is evaluated according to a magnitude of a minimum margin with respect to NEXT required for the communication cable of Category 6A.

### Bending Durability Testing Method for Examples 1 and 2

The bending durability of the communication cable 10 was evaluated by a bending durability tester 100 shown in FIG. 5. The test condition was that the communication cable 10 having a length of 1000 mm, of which an upper portion was fixed by a fixing section 101 and to which a load 103 of 500 g was attached, was lightly sandwiched between mandrels 102 of R 20 mm and bent to right and left each by 90 degrees at a speed of 60 times/minute. An operation of bending the communication cable 10 to right and left each by 90 degrees was counted as one bending operation, and after the communication cable 10 was bent 100,000 times, NEXT was measured and compared with NEXT before bending the same.

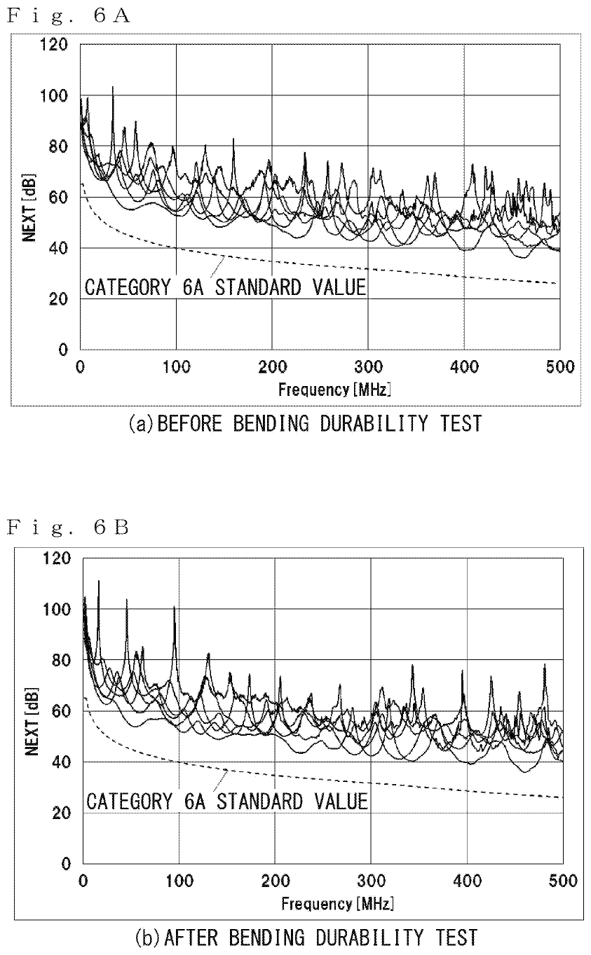

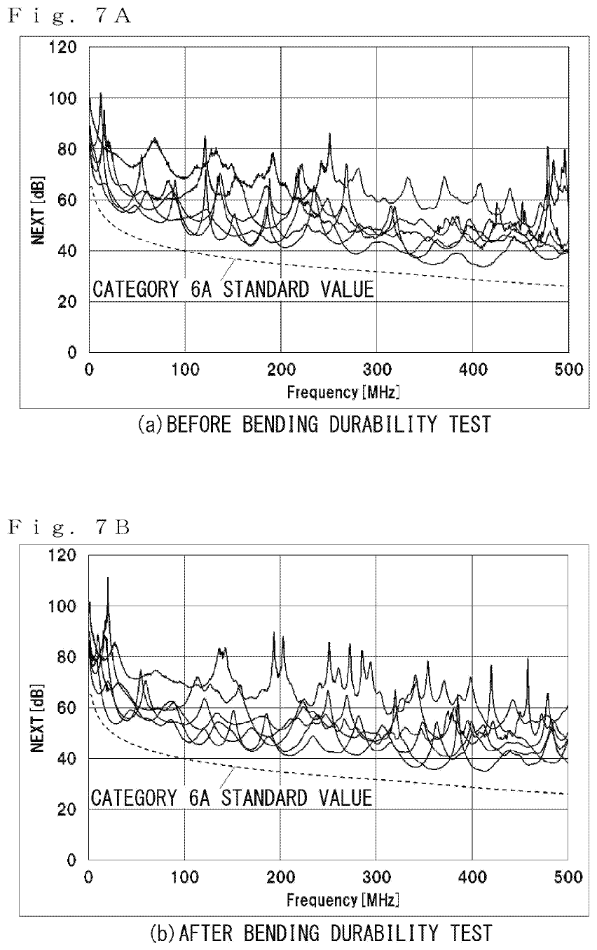

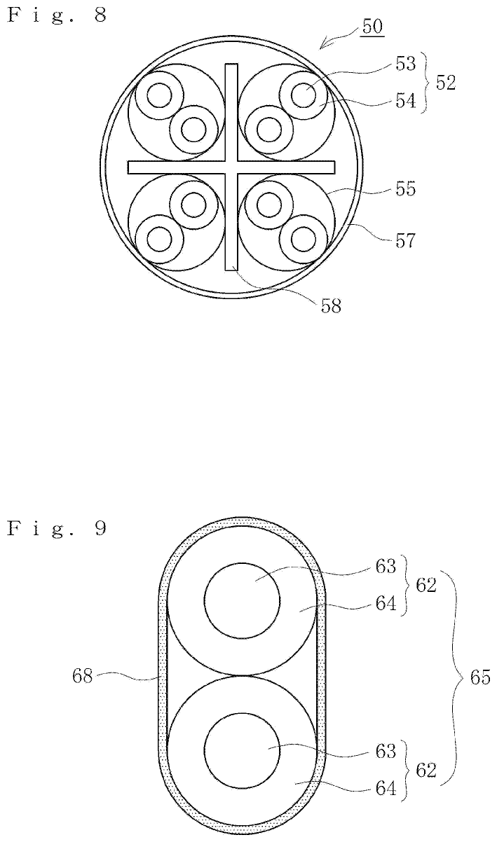

A table 1 shows the design and the evaluation results of the communication cable 10 of Examples 1 and 2, and FIGS. 6A, 6B, 7A, and 7B show NEXT of Examples 1 and 2 before and after the bending durability test.

TABLE 1

| | | | | Example | |
|---|---|---|---|---|---|
| No. | | | | 1 | 2 |
| Twisted | Signal | Conductor | Material | Tin-plated | Tin-plated |
| wire | wire | | | soft | soft |
| pair | | | | copper wire | copper wire |
| | | | Configuration | ϕ0.26 strand | ϕ0.08 strand |
| | | | | Single wire | Seven wires |
| | | | | | coaxially |
| | | | | | twisted |
| | | Insulating | Material | FEP | FEP |
| | | layer | Thickness[mm] | 0.16 | 0.095 |
| | Filler cord | | Material | PTFE | PTFE |
| | | | Thickness[mm] | 0.38 | 0.42 |

| | | | |
|---|---|---|---|
| Tape layer | Material | Aluminum | Aluminum |
| | | laminated | laminated |
| | | PET | PET |
| Shield layer | Strand | ϕ0.08 | ϕ0.08 |
| | | copper | copper |
| | | foil thread | foil thread |
| | Bundle | 8 strands | 8 strands |
| | configuration | arranged in | arranged in |
| | | parallel | parallel |
| | Number of | 16 | 16 |
| | bundles | | |
| Outer sheath | Material | PVC | PVC |
| | Thickness[mm] | 0.4 | 0.4 |
| NEXT (minimum | Before bending | +8.9 | +4.3 |
| margin) | durability test | | |
| | [dB] | | |
| | After bending | +8.9 | +3.8 |
| | durability test | | |
| | [dB] | | |

The communication cable 10 of Example 1 had a minimum margin of +8.9 dB with respect to a standard value defined by Category 6A, and this value was not changed after the bending durability test. From this fact, it can be said that the communication cable 10 of Example 1 is a communication cable that preserves the communication characteristics even after repeatedly bent and is excellent in bending durability.

The communication cable 10 of Example 2 had a minimum margin of +4.3 dB with respect to the standard value defined by Category 6A, and this value decreased to +3.8 dB after the bending durability test. From this fact, although lowering of the communication characteristics was caused when repeatedly bent, the margin with respect to the characteristics required by Category 6A still remains, and therefore it can be said that the communication cable 10 of Example 2 is a communication cable for Category 6A, which has practical bending durability, and is a communication cable having sufficient performance as a communication cable for Category 6A at the same time.

From the results of Examples 1 and 2, the diameter of the filler cord 16, as a component of the twisted wire pair 15, that is made smaller than the diameter of the signal wire 12 based on the above expression (2) is more preferable for the communication characteristics and the bending durability than the diameter of the filler cord 16 made substantially equal to the diameter of the signal wire 12.

### Transmission Characteristics Evaluation Method for Example 3 and Comparative Example

The quality of the transmission characteristics was evaluated according to a magnitude of a conductor resistance value of the signal wires 2 as components of the communication cable 1. Measurement of the conductor resistance value was performed such that the conductors 3 of the two signal wires 2 as components of the communication cable 1 were brought into contact with each other at one end of the communication cable 1 cut to a predetermined length, and a test lead of a plus side of a tester was connected to the conductor 3 of one of the signal wires 2 while a test lead of a minus side was connected to the conductor 3 of the other of the signal wires 2, at the other end of the communication cable 1. The measurement was performed at a normal temperature, and the quality of the transmission characteristics was evaluated. Note that as the conductor resistance value is higher, the transmission characteristics are lowered.

### Bending Durability Testing Method for Example 3 and Comparative Example

The bending durability of the communication cable 1 was also evaluated with respect to Example 3 by the bending durability tester 100 shown in FIG. 5. The test condition was that the communication cable 1 having a length of 1000 mm, of which an upper portion was fixed by the fixing section 101 and to which a load 103 of 100 g was attached, was lightly sandwiched between the mandrels 102 of R 3 mm and bent to right and left each by 90 degrees at a speed of 90 times/minute. An operation of bending the communication cable 1 to right and left each by 90 degrees was counted as one bending operation, and the conductor resistance value changed in accordance with an increase in the number of bending times was measured and compared with the conductor resistance value before bending the same.

A table 2 shows the design and the evaluation results of the communication cable 1 of Example 3 and Comparative Example.

TABLE 2

| | | | | | Comparative |
|---|---|---|---|---|---|
| | | | | Example | example |
| No. | | | | 3 | — |
| Twisted | Signal | Conductor | Material | Tin-plated | Tin-plated |
| wire | wire | | | copper alloy | copper alloy |
| pair | | | Configuration | 3 twisted | 3 twisted |
| | | | | wires each | wires each |
| | | | | formed by | formed by |
| | | | | twisting 7 | twisting 7 |
| | | | | ϕ0.05 | ϕ0.05 |
| | | | | strands | strands |
| | | Insulating | Material | FEP | FEP |
| | | layer | Thickness[mm] | 0.15 | 0.15 |
| | Filler cord | | Material | PTFE | none |
| | | | Thickness[mm] | 0.38 | — |

| | | | |
|---|---|---|---|
| Shield layer | Strand | ϕ0.08 | ϕ0.08 |
| | | copper | copper |
| | | foil thread | foil thread |
| | Bundle | 7 strands | 7 strands |
| | configuration | arranged in | arranged in |
| | | parallel | parallel |
| | Number of | 24 | 24 |
| | bundles | | |
| Outer sheath | Material | PVC | PVC |
| | Thickness[mm] | 0.4 | 0.4 |
| Conductor resistance | Before bending | 600 | 600 |
| value | durability test | | |
| | [mΩ] | | |
| | Bent 16,000 | 600 | 690 |
| | times [mΩ] | | (disconnected) |
| | Bent 160,000 | 612 | — |
| | times [mΩ] | | |

The conductor resistance value of the communication cable 1 of Example 3 indicated 600 mΩ, which is a value at which there is no inconvenience when used as a communication cable, and did not change when the number of bending times reached 16,000, but increased to 612 mΩ, when the number of bending times reached 160,000. The rise amount was 2%, which is a rise of a degree at which there is no particular inconvenience when used as a communication cable. Further, disconnection of the conductors 3 as components of the signal wire 2 was not confirmed.

On the other hand, the conductor resistance value of the communication cable of Comparative Example indicated 600 mΩ, equal to that of Example 3 before the bending durability test, but increased to 690 mΩ, by 10% or more when the number of bending times reached 16,000, and disconnection of the conductors was confirmed at the same time. As to the communication cable of Comparative Example, it is estimated that disconnection of the conductors progressed due to load generated by bending and the conductor resistance value rose, and as to the communication cable 1 of Example 3, it is estimated that load generated by bending was absorbed by the filler cords 6, and progress of disconnection was suppressed by reduction of the load applied to the conductors 3.

From the above, it can be said that the communication cable 1 of Example 3 is a communication cable that preserves the communication characteristics even after repeatedly bent and is excellent in bending durability.

As described above, the present inventor diligently studied the structure of the communication cable, and as a result, has found that if compression of the covers of the signal wires existing in the twisted wire pair as components of the communication cable is suppressed, and a signal wire as a component of the adjacent twisted wire pair is prevented from dropping in a space between the signal wires, practically sufficient communication characteristics can be obtained, thereby eventually obtaining the communication cable that suppresses compression of the cover and dropping of the signal wire and is improved in durability to bending.

Further, advantageous effects, described below, can be expected from the communication cable of the present disclosure:

(1) Compression of the covers of the signal wires as components of the twisted wire pair is suppressed, and a predetermined distance between the conductors is maintained even when the communication cable is bent, and therefore, predetermined communication characteristics are preserved.
(2) It is possible to obtain the predetermined communication characteristics while reducing a change in the outer diameter of the twisted wire pair to the minimum, which contributes to thinning of the diameter of the communication cable.
(3) In a case where the communication cable is formed by using a plurality of twisted wire pairs, the communication cable has excellent communication characteristics even when a cross-shaped filler is not used, and since the cross-shaped filler is not provided, the bending durability is improved, compared with a communication cable using a cross-shaped filler.
(4) In a case where the communication cable is formed by using a plurality of twisted wire pairs, the twisted wire pairs are suppressed from becoming abnormally close to each other, and the predetermined communication characteristics are preserved even when the communication cable is bent.

This application claims the benefit of Japanese Patent Application No. 2019-085722, filed on Apr. 26, 2019, the entire disclosure of which is incorporated by reference herein.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

As described above, although the communication cable of the present disclosure is preferably used for movable parts of robots including various service robots, such as an industrial robot and a humanoid, and various industrial apparatuses, such as a semiconductor manufacturing apparatus, the use is not limited to these, but can also be preferably used as a communication cable used for part other than the movable part, or a power supply cable for a movable part without a communication function.

### REFERENCE SIGNS LIST

1 Communication cable
2 Signal wire
3 Conductor
4 Insulating layer
5 Twisted wire pair
6 Filler cord
7 Outer sheath
8 Shield layer
10 Communication cable
12 Signal wire
13 Conductor
14 Insulating layer
15 Twisted wire pair
16 Filler cord
17 Outer sheath
18 Shield layer
19 Tape layer

1. A communication cable comprising:
a twisted wire pair formed by twisting together signal wires each provided with an insulating layer for covering a conductor, and
an outer sheath that accommodates the twisted wire pair, wherein
the twisted wire pair includes a pair of the signal wires and a pair of filler cords, and the signal wires and the filler cords are twisted together such that the signal wires and the filler cords are alternately arranged side by side.

2. The communication cable according to claim 1, wherein a shield layer is provided between the twisted wire pair and the outer sheath.

3. A communication cable comprising:
a twisted wire pair formed by twisting together signal wires each provided with an insulating layer for covering a conductor, and
an outer sheath that accommodates the twisted wire pair, wherein
the twisted wire pair includes a pair of the signal wires and a pair of filler cords, and the signal wires and the filler cords are twisted together such that the signal wires and the filler cords are alternately arranged side by side, and
an assembled wire formed by twisting a plurality of the twisted wire pairs together is covered with the outer sheath.

4. The communication cable according to claim 3, wherein a shield layer is provided between the assembled wire and the outer sheath.

5. The communication cable according to claim 1, wherein in a cross-sectional view of the twisted wire pair on a plane orthogonal to a longitudinal direction, a pair of signal wires as components of the twisted wire pair are in contact with each other.

6. The communication cable according to claim 1, wherein an outer diameter of the filler cord is smaller than an outer diameter of the signal wire.

7. The communication cable according to claim 1, wherein when an outer diameter of the filler cord is defined as R₁ and an outer diameter of the signal wire is defined as R₂, a relationship expressed by an expression (1) is satisfied.
$$( \frac{2 \cdot \sqrt{3}}{3} - 1 ) {R}_{2} \leq {R}_{1} \qquad ( 1 )$$

8. (canceled)

9. The communication cable according to claim 1, wherein when an outer diameter of the filler cord is defined as R₁ and an outer diameter of the signal wire is defined as R₂, a relationship expressed by an expression (3) is satisfied.
$$( \frac{2 \cdot \sqrt{3}}{3} - 1 ) {R}_{2} \leq {R}_{1} \leq \frac{2}{3} {R}_{2} \qquad ( 3 )$$

10. The communication cable according to claim 1, wherein elongation of the filler cord is greater than or equal to elongation of the signal wire.

11. The communication cable according to claim 1, wherein elongation of the filler cord is greater than or equal to 10 times of elongation of the signal wire.

12. The communication cable according to claim 1, wherein the filler cord is formed of a material having a kinetic coefficient of friction that is less than or equal to 0.3.

13. The communication cable according to claim 1, wherein the filler cord is formed of a material having a static coefficient of friction that is less than or equal to a kinetic coefficient of friction.

14. The communication cable according to claim 3, wherein in a cross-sectional view of the twisted wire pair on a plane orthogonal to a longitudinal direction, a pair of signal wires as components of the twisted wire pair are in contact with each other.

15. The communication cable according to claim 3, wherein an outer diameter of the filler cord is smaller than an outer diameter of the signal wire.

16. The communication cable according to claim 3, wherein when an outer diameter of the filler cord is defined as R₁ and an outer diameter of the signal wire is defined as R₂, a relationship expressed by an expression (1) is satisfied.
$$( \frac{2 \cdot \sqrt{3}}{3} - 1 ) {R}_{2} \leq {R}_{1} \qquad ( 1 )$$

17. The communication cable according to claim 3, wherein when an outer diameter of the filler cord is defined as R₁ and an outer diameter of the signal wire is defined as R₂, a relationship expressed by an expression (3) is satisfied.
$$( \frac{2 \cdot \sqrt{3}}{3} - 1 ) {R}_{2} \leq {R}_{1} \leq \frac{2}{3} {R}_{2} \qquad ( 3 )$$

18. The communication cable according to claim 3, wherein elongation of the filler cord is greater than or equal to elongation of the signal wire.

19. The communication cable according to claim 3, wherein elongation of the filler cord is greater than or equal to 10 times of elongation of the signal wire.

20. The communication cable according to claim 3, wherein the filler cord is formed of a material having a kinetic coefficient of friction that is less than or equal to 0.3.

21. The communication cable according to claim 3, wherein the filler cord is formed of a material having a static coefficient of friction that is less than or equal to a kinetic coefficient of friction.
